(19) United States
(12) Patent Application Publication
(10) Pub. No.: US 2006/0266841 A1
(43) Pub. Date: Nov. 30, 2006

(54) Handheld computer with interchangeable keypad/battery module

(76) Inventors: Joshua M. Hansen, Everett, WA (US); John Bandringa, Everett, WA (US)

Correspondence Address: Orum & Roth LLC, 53 West Jackson Blvd., Chicago, IL, 60604, US

(21) Appl. No.: 11/139,811

(22) Filed: May 27, 2005

(51) Int. Cl. G06K 7/10

(52) U.S. Cl. 235/472.02

(57) ABSTRACT

The present invention is a modular handheld device. The modular handheld comprises a console and a keypad/battery module that acts with the console. The handheld can have other module parts. For example different modular handles can be attached to the handheld. The user or user organization has the option to select from one or more smaller keypad/battery battery modules and/or one or more larger keypad/battery modules with more battery capacity. The appropriate keypad/battery module is selected based on the needs of the particular user or application. This allows an organization to have multiple handheld configurations which utilize the same core computing engine, thus greatly reducing the number of IT platforms that need to be supported. By combining the display, processor, scan engines and radios into a console and separating the keypad and batteries into a “personality module” many different handhelds can be customized from a single console.

### BACKGROUND OF THE INVENTION

1. Field of the Invention

The present invention relates to handheld computing devices. More particularly, it relates to handheld computing devices with a modular keypad and battery pack.

2. Descrption of Related Art

Within the retail market there are many uses for handheld devices. Often a single organization has need for several different handheld devices. Different applications do not require different displays or processors. However, the auxiliary functionality and battery means may vary significantly depending on the particular use of the handheld. The requirement of different auxiliary functionality often dictates the minimum keypad needs or size. Keypad size, battery capacity and auxiliary functionality all directly affect the size of the handheld. Some applications need large, full functioning handhelds while ruggedized PDAs are sufficient for other applications. By utilizing a handheld that has a console module and a keypad/battery module, users have the flexibility to customize the handheld to a particular application, while only managing one platform one operating system.

### SUMMARY OF THE INVENTION

The present invention is a modular handheld device. The modular handheld comprises a console and a keypad/battery module that acts with the console. The handheld can have other module parts. For example different modular handles can be attached to the handheld.

The user or user organization has the option to select from one or more smaller keypad/battery battery modules and/or one or more larger keypad/battery modules with more battery capacity. The appropriate keypad/battery module is selected based on the needs of the particular user or application. This allows an organization to have multiple handheld configurations which utilize the same core computing engine, thus greatly reducing the number of IT platforms that need to be supported. By combining the display, processor, scan engines and radios into a console and separating the keypad and batteries into a “personality module” many different handhelds can be customized from a single console.

Keypads and batteries are high wear items. By modulizing these items they can be easily replaced by the end user. Further, as a new consoles are developed with a faster processor, end users can replace the console portion without the cost of replacing the entire system.

### BRIEF DESCRIPTION OF THE FIGURES

FIG. 1A is a console.

FIGS. 1B-1F are different embodiments of the keypad/battery module.

FIGS. 1G-1J are different embodiments of the handle module.

FIG. 2A is a front view of a console.

FIG. 2B is a side view of the console of FIG. 2A.

FIG. 2C as a back view of the console of FIG. 2A.

FIG. 2D is a top view of the console of FIG. 2A.

FIGS. 3A-C our embodiments of the keypad/battery module.

FIG. 4 is an exploded view of the inventive handheld.

FIG. 5A is an interior detail of a sliding module latch.

FIG. 5B is an exterior detail of a sliding module latch.

FIG. 6A-C are embodiments of the inventive handheld.

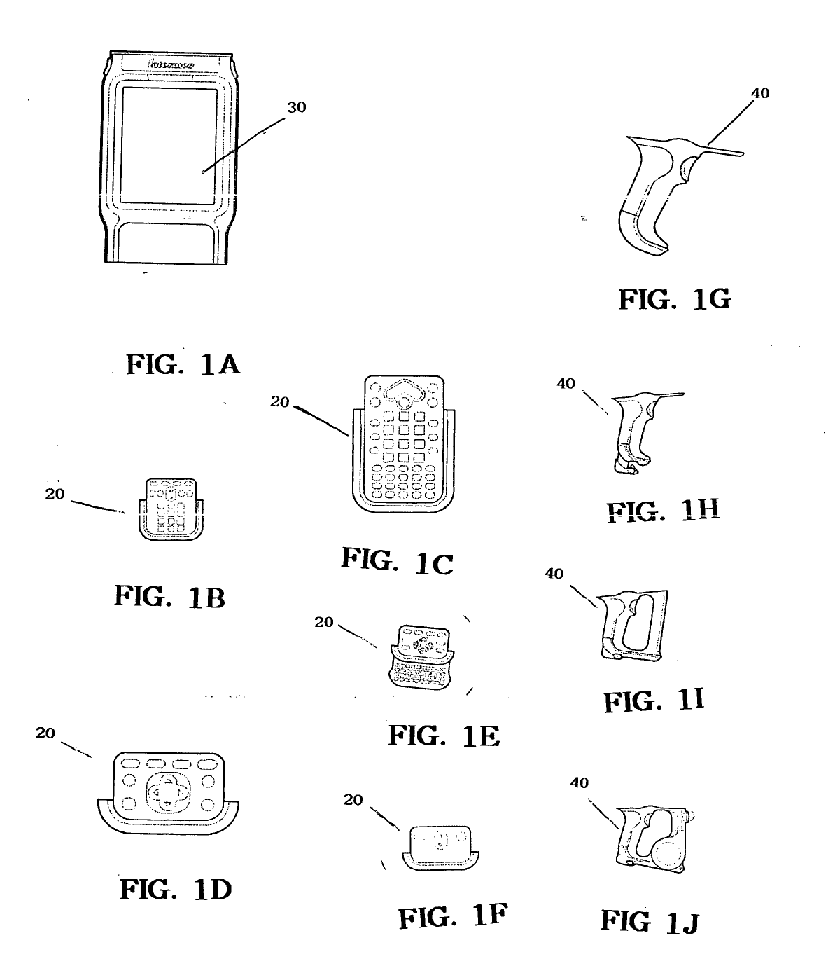

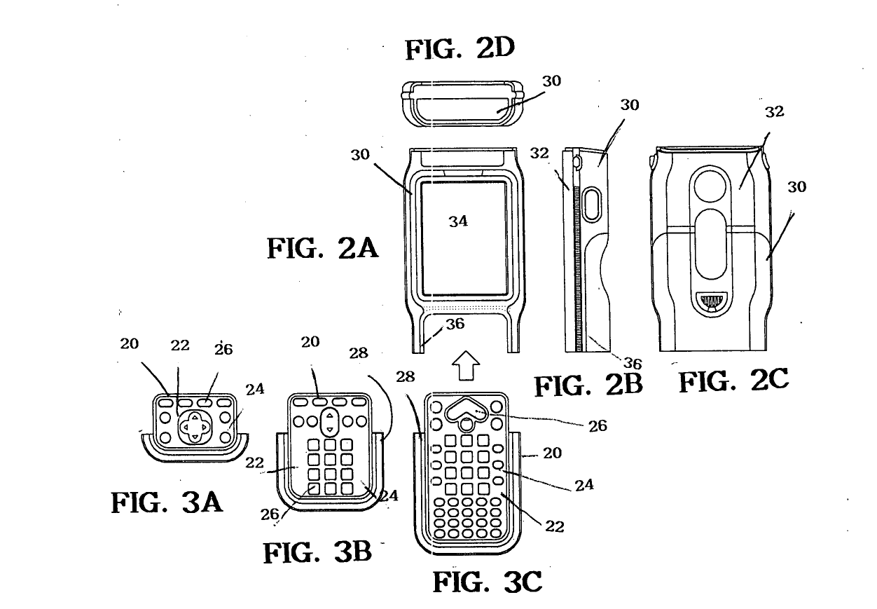

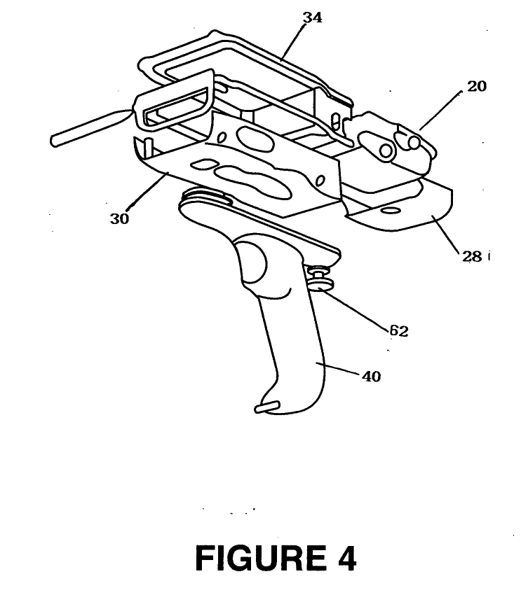

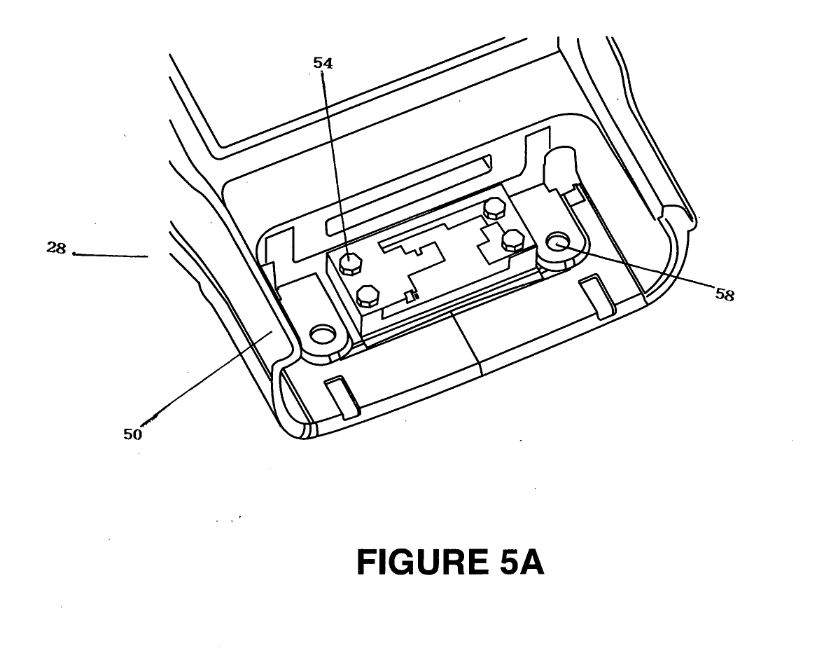

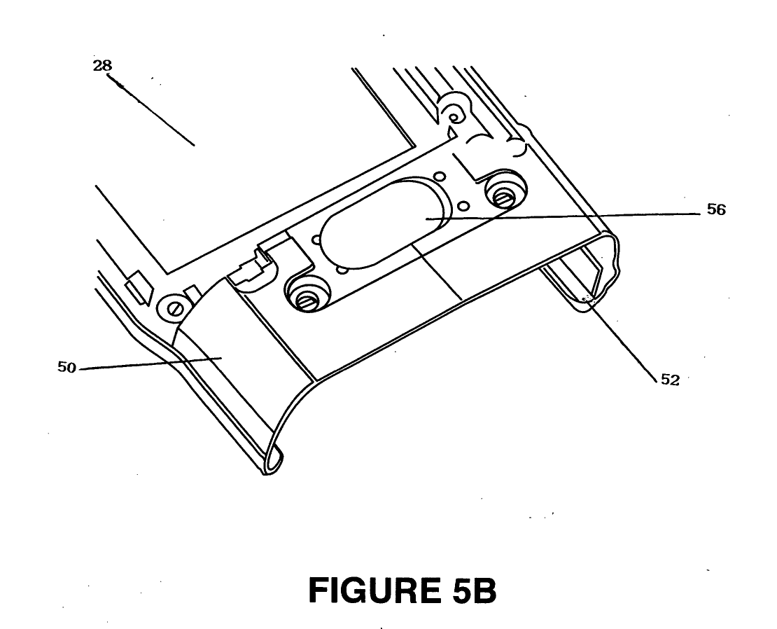

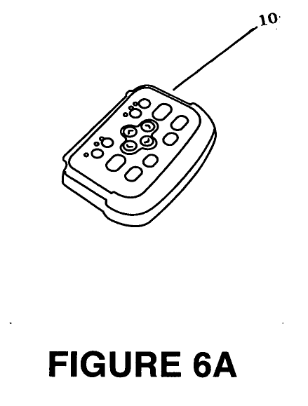

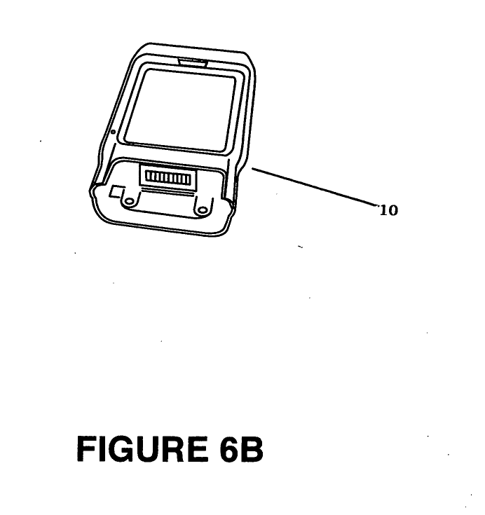

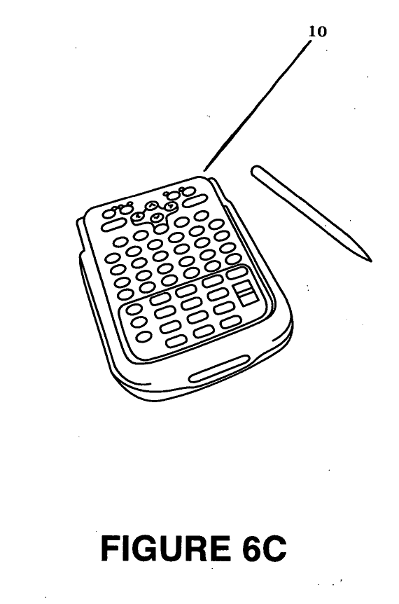

### DETAILED DESCRIPTION OF THE INVENTION

The inventive handheld computer 10 has an interchangeable keypad/battery module 20. The handheld comprises a console 30 and a removable keypad/battery module 20. Optionally, the handheld includes a handle module 40. The console 30 comprises a housing 32 and one or more of the following display 34, processor, scanner, printer, radio, interrogator, and wireless data transfer device. Console 30 further comprises a locking base 36. The locking base 36 is adapted to mate with the locking element 28 of the module 20. Console 30 optionally comprises a charge element and handle mounting element.

The keypad/battery module 20 comprises a module housing 22, a keypad 24 with one or more buttons 26, power supply and a locking element 28 adapted to mate with the console 30. The buttons 26 can be integral with the face of the keypad 24 or may be made of a different material. The buttons 26 can be flush with the face of the keypad 24, protrude from the face of the keypad 24, or be depressions in the face of the keypad 24. Optionally, the keypad/battery module 20 comprises a charging element.

Locking element 28 is preferably a sliding latch 50 that mates with the console to prevent separation of the keypad/battery module 20 from the console 30 if the handheld 10 is dropped or subjected to other extreme conditions. The sliding latch 50 comprises at least one rib 52 that mates with at least one channel on said console 30. Alternatively, a channel in the locking element 28 can mate with a rib on the console 30. The sliding latch 50 optionally has a button 56 or other mechanism to release the latch if the user wants to replace the keypad battery module 20. Alternatively, locking element 28 can be a side mounted push button release mounted on the side of the console or module 20 or locking element can be rear mounted push button release mounted on the rear of the locking element 28. Optionally threaded inserts 58 can be provided on the module which are adapted to align with threaded inserts on the console 30. A screw 62 is mated with the threaded inserts.

The electrical interface between the module and the console is preferably a series of spring contacts 64, such as pogo pins, which create a reliable electrical connection 54. Optionally, a electrical connector between the console in module can be a standard USB interface. There is a seal between the module 20 and console 30. The seal can be any type of known seal. It's preferable to seal the module the console and the connection between them. One the embodiment of the seal is a foam gasket surrounding a locking base 28 that is compressed when the module 20 is inserted and exposed with the module 20 is removed.

The housing 22 of the module is preferably one-piece housing having a cavity. Preferably, the housing is made of magnesium, which is lightweight and has high strength.

In is preferable that any modules 20 and/or consoles 30 that require charging and/or docking will share identical charging/docking elements. This is preferred, so that any handheld can use the same peripheral.

A user will have an IT support structure, and one or more consoles 30. For each console 30, the user will customize the console 30 with a keypad/battery modules 20 selected for the desired application. The appropriate keypad/battery module 20 is connected to the console 30 to create a customized handheld. The appropriate keypad/battery module 20 is selected based on for example, the individual user, the application(s), the data entry/retrieval/transfer needs, and the battery life requirements. Some applications will require keypads 24 with a plurality of buttons 26 and others will require fewer buttons 26. The user will have other customized handheld devices with different keypad/battery modules 20 to be used with different applications. Each of the user's customized handheld 20 is operable with the same IT platform, charging devices, and other peripherals.

In an alternative embodiment, the user selects the handheld 10 comprising interchangeable consoles 30 as well as interchangeable keypad/battery modules 20. An appropriate console 30 may be selected based on the desired application. For example, the for some applications it maybe desirable to have a scanner and a printer. For other applications, a printer may not be needed. For others, both a scanner and an RFID interrogator may be needed.

1. A handheld device comprising:
a console and a removable keypad/battery module,
said console comprising a housing, said housing retaining one or more of the following: display, processor, scanner, printer, radio, interrogator, and wireless data transfer device in the interior of said housing, and a locking platform on the exterior of said housing; and
said keypad/battery module comprising a keypad having one or more buttons, a power supply, and a locking element, said locking element adapted to mate with said locking platform.

2. The handheld device of claim 1 further comprising a removeable handle module.

3. The handheld device of claim 1 wherein the keypad/battery module further comprises a housing retaining said keypad and said power supply and said locking element is a sliding latch.

4. The handheld device of claim 1 wherein the keypad/battery module can be replaced by a second keyboard/battery module comprising a second keypad having a different configuration of buttons and/or a different power supply and keypad battery module.

5. The handheld device of claim of claim 3 wherein the housing is made of magnesium.

6. The handheld device of claim 1 further comprising an electrical interface between said console and said keypad/battery module.

7. The handheld device of claim 6 wherein said electrical interface is on said locking platform and said locking element.

8. The handheld device of claim 7 wherein said electrical interface is a series of spring contacts on said locking platform and said locking element.

9. The handheld device of claim 1 wherein said locking element is a sliding latch is sliding latch having a rib of the adapted to mate with a channel on the locking platform.

10. The handheld device of claim 3 further comprising a seal between the console housing and the module housing.

11. The handheld device of claim 10 wherein the seal seals an electrical connection between the console and the module.

12. The handheld device of claim 3 further comprising a security screw threaded to an aperture in said housing of said console and an aperture in said housing of said keypad/battery module, wherein the aperture in said console and said aperture in said keypad/battery module adapted to align when the console and keypad/battery module are mated.

13. A system of handheld devices comprising:
a plurality of handheld devices and an electronic platform adapted to work with the plurality of handheld devices,
each said handheld device comprising:
a console comprising a housing, said housing retaining retaining one or more of the following: display, processor, scanner, printer, radio, interrogator, and wireless data transfer device in the interior of said housing, and a locking platform on the exterior of said housing; and
a removeable keypad/battery module, said removable keypad/battery module comprising a keypad having one or more buttons and a power supply retained by a housing and a locking element, said locking element adapted to mate with said locking platform of said console to electrically interface said console and said keypad/battery module; wherein said removeable keypad/battery module selected from a group comrprising at least a first module comprising a first keypad having one or more buttons, a first power supply, and a locking element, and a second module comprising a second keypad having one or more buttons, a second power supply, and a locking element, said second module having a different configuration of said buttons than said first module and/or said second power supply being different than said first power supply.

14. The system of claim 13 wherein each said handheld device further comprises a substantially identical peripheral interface.

15. The system of claim 14 were each of said handheld devices is adapted to be used with the same peripherals.

16. The system of claim 14 wherein the first module can be replaced by the second module.

17. The system of claim 13 wherein the consoles are substantially identical.

18. The system of claim 13 wherein the consoles comprise a plurality of different consoles adapted to mate with the plurality of keypad/battery modules.

19. A method of customizing a handheld device comprising the steps of:
selecting a keypad/battery module from a plurality of keypad/battery modules having different keypad/battery configurations and adapted to mate with a console,
mating said selected keypad/battery module with the console.

20. Method of claim 19 comprising the steps of
removing the selected keypad/battery module from the console,
selecting a second keypad/battery module,
mating said second keypad/battery module with the console.
